(19) United States
(12) Patent Application Publication
(10) Pub. No.: US 2021/0362289 A1
(43) Pub. Date: Nov. 25, 2021

(54) ELECTRIC WORK MACHINE

(71) Applicant: Koki Holdings Co., Ltd., Tokyo (JP)

(72) Inventors: Kyouichi NAKAYAMA, Ibaraki (JP); Ken MIYAZAWA, Ibaraki (JP); Ryo Suzuki, Ibaraki (JP)

(73) Assignee: Koki Holdings Co., Ltd., Tokyo (JP)

(21) Appl. No.: 17/257,309

(22) PCT Filed: Sep. 6, 2019
(86) PCT No.: PCT/JP2019/035217

§ 371 Date: Dec. 31, 2020

(30) Foreign Application Priority Data
Sep. 14, 2018 (JP) 2018-172169

(51) Int. Cl. B24B 23/02; B24B 55/02; B25F 5/02; B25F 5/00

(52) U.S. Cl. CPC B24B 23/028; B24B 55/02; B25F 5/008; B25F 5/001; B25F 5/02

(57) ABSTRACT

Provided is an electric work machine in which it is possible to limit the risk of contact between a control unit and wiring provided inside a motor housing. In the electric work machine (1A), a motor (6) and a control unit (13) are housed inside a motor housing (2). A gear case (4) is connected in front of the motor housing (2) and a handle housing (3) is connected behind the motor housing (2). The motor housing (2) is an integrally molded cylinder. Electrical connection between the wiring of the motor (6) and the wiring of the control unit (13) is accomplished by connectors (23), which are inside the handle housing (3) that is outside of and behind the motor housing (2). The control unit (13) has a switching element for conducting electricity to the motor (6).

### BACKGROUND

### Technical Field

The invention relates to an electric work machine having a motor and a control unit inside a motor housing.

### Description of Related Art

With the increasing output of electric tools, there is known a configuration in which a heat generating element or a heat dissipation member connected to the heat generating element is exposed to the outside where cooling air flows through in order to cool the heat generating element (hereinafter referred to as “element exposure configuration”).

### RELATED ART

### Patent Document

[Patent Document 1] Japanese Laid-Open No. 2016-203329

### SUMMARY

### Problems to be Solved

In the case of the element exposure configuration, an electric element or a member that may conduct electricity thereto may come into contact with a part, from which the insulating coating is removed, of a wiring such as a power line and cause a problem. In particular, for example, when the above-described element exposure configuration is adopted in a configuration that houses a control unit such as a controller inside a motor housing which houses a motor, the wiring (particularly, the portion with the insulating coating removed) may come into contact with the electricity conducting portion or the heat generating portion of the control unit.

The invention has been made in view of such a situation, and provides an electric work machine capable of preventing contact between the control unit and the wiring provided inside the motor housing.

### Means for Solving the Problems

An embodiment of the invention is an electric work machine. The electric work machine includes a motor housing that houses a motor and a first control unit that controls the motor. An electrical connection part between the motor and the first control unit is positioned outside the motor housing.

The first control unit may include a switching element for conducting electricity to the motor.

A holder may be provided on the electrical connection part side of the motor housing and a plurality of holder through holes may be provided in the holder, and the motor side wiring may be inserted into the holder through hole. In addition, the control unit side wiring may be inserted into the holder through hole at a position different from the holder through hole through which the motor side wiring passes.

A gear case may be connected to one side of the motor housing, and the electrical connection part may be positioned on the other side with respect to the motor housing. A handle housing may be provided on the other side of the motor housing, and the electrical connection part may be positioned inside the handle housing.

A fan rotated by the motor, and an intake port and an exhaust port for generating a flow of air for cooling the motor by the rotation of the fan may be provided. The air flowing in from the intake port may flow into the motor housing through the holder through holes.

The electrical connection part between the motor and the first control unit may have a connector, and a holder that holds the connector may be provided on the other side of the motor housing.

The motor housing may have a cylindrical integral structure that is molded so as not to be divided.

The motor may be a brushless motor, and the first control unit may be an inverter circuit that controls power supply to the motor.

Any combination of the above components and any aspect obtained by converting the expression of the invention between methods and systems are also effective as aspects of the invention.

### Effects

According to the invention, it is possible to provide an electric work machine capable of preventing contact between a control unit and a wiring provided inside a motor housing.

### BRIEF DESCRIPTION OF THE DRAWINGS

FIG. 1 is a side cross-sectional view of the electric work machine 1A according to the first embodiment of the invention.

FIG. 2 is an explanatory view of assembly of the motor housing 2, the motor 6, the control unit 13, and the holder 17 of the electric work machine 1A.

FIG. 3 is a rear view of the motor housing 2, incorporating the motor 6, of the electric work machine 1A.

FIG. 4 is a rear view of the motor housing 2 incorporating the control unit 13 from the state of FIG. 3.

FIG. 5 is a rear view of a state where the holder 17 is installed on the motor housing 2 of FIG. 4.

FIG. 6 is a rear view of a state where the wirings 6w and 47w of FIG. 5 are connected to each other by the connectors 23.

FIG. 7 is a side cross-sectional view of the electric work machine 1B according to the second embodiment of the invention.

FIG. 8 is a rear view of the motor housing 2, incorporating the motor 6, of the electric work machine 1B.

FIG. 9 is a rear view of the motor housing 2 incorporating the bridge/inverter board 30 from the state of FIG. 8.

FIG. 10 is a rear view of a state where the holder 17 is installed on the motor housing 2 of FIG. 9.

FIG. 11 is a rear view of a state where the connectors 6n and 47n of FIG. 10 are connected to each other and fitted into the recesses 17b of the holder 17.

FIG. 12 is a circuit diagram of the electric work machine 1B.

### DESCRIPTION OF THE EMBODIMENTS

Hereinafter, preferred embodiments of the invention will be described in detail with reference to the drawings. The same or equivalent components, members, and the like shown in each drawing are denoted by the same reference numerals, and repeated descriptions will be omitted where appropriate. In addition, the embodiments are exemplary and are not intended to limit the invention, and all the features described in the embodiments and combinations thereof are not necessarily essential to the invention.

### First Embodiment

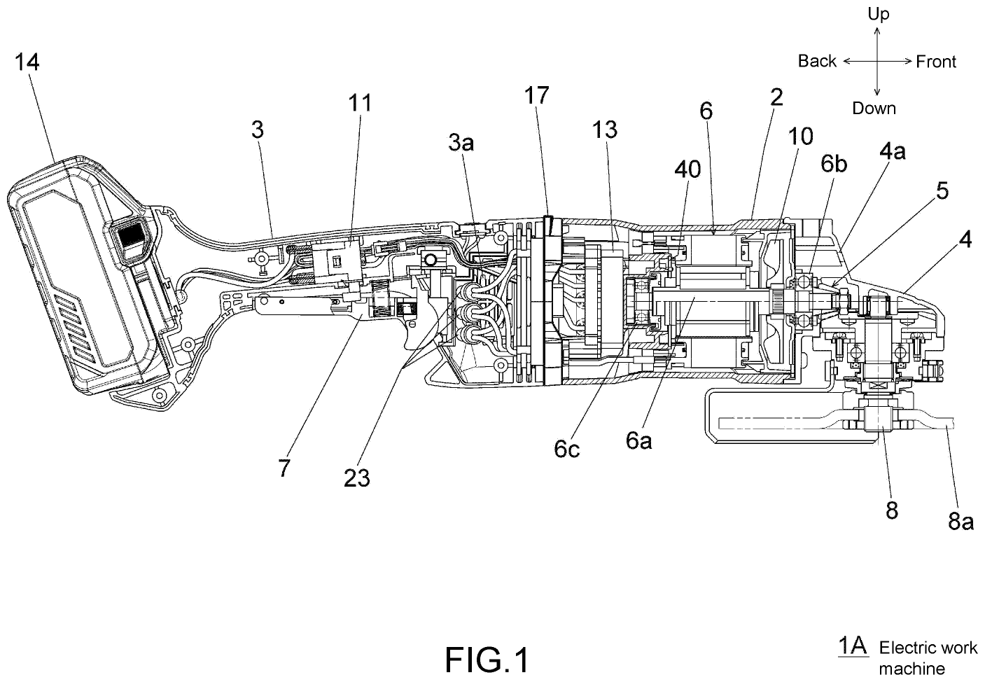

With reference to FIG. 1 to FIG. 6, an electric work machine 1A according to the first embodiment of the invention will be described. The up-and-down and front-and-back directions of the electric work machine 1A are defined by FIG. 1. The front-and-back direction is parallel to the extending direction of a rotation shaft 6a of a motor 6. The electric work machine 1A is a cordless type grinder that operates with the power supplied from a battery pack 14 which is detachably installed.

The electric work machine 1A has an outer shell formed by a motor housing 2, a handle housing (tail cover) 3, and a gear case 4. The handle housing 3 is attached (connected) to the rear end of the motor housing 2 via a holder (intermediate member) 17, and the gear case 4 is attached (connected) to the front end of the motor housing 2. The motor housing 2 and the handle housing 3 are, for example, resin molded bodies. The gear case 4 is made of metal such as aluminum. The gear case 4 supports a bearing 6b that rotatably supports the front portion of the rotation shaft 6a.

The battery pack 14 serving as a power supply source of the electric work machine 1A is detachably installed at the rear end of the handle housing 3. The handle housing 3 constitutes a handle of the electric work machine 1A. A trigger 7 is swingably (rotatably) supported on the lower portion of the handle housing 3. The trigger 7 is an operation part for the user to turn on/off a first switch 11 provided in the current path of the motor 6. The first switch 11 is preferably a mechanical contact switch, and is housed inside the handle housing 3 and positioned above the trigger 7. When the user holds the trigger 7, the trigger 7 swings upward and the first switch 11 is turned on. When the user releases the trigger 7, the trigger 7 swings downward and the first switch 11 is turned off.

The motor housing 2 has a cylindrical integral structure such as a cylindrical shape that extends in the front-and-back direction and is molded so as not to be divided, and has a front end and a rear end that are open. The motor housing 2 houses the motor 6 and a control unit 13 in the rear portion of the motor 6. The control unit 13 includes an inverter circuit that controls the power supply to the motor 6, a microcomputer (microcontroller) that controls the inverter circuit, etc. The motor 6 is an inner rotor type brushless motor. Further, a fan 10 for cooling the motor 6 and the control unit 13 is provided in the front portion of the motor housing 2. The fan 10 is configured to rotate integrally with the rotation shaft 6a, and by the rotation, generates cooling air from the intake ports 3a provided on the left and right of the handle housing 3 to the exhaust ports 4a provided on the gear case 4. That is, the air flowing into the handle housing 3 from the intake ports 3a due to the rotation of the fan 10 flows into the motor housing 2 as cooling air, and cools the control unit 13 and then cools the motor 6 to be discharged from the exhaust ports 4a to the outside. A deceleration mechanism 5 serving as a rotation transmission mechanism is housed inside the gear case 4. The deceleration mechanism 5 is a combination of a pair of bevel gears. The deceleration mechanism 5 decelerates the rotation of the motor 6 and converts it by 90 degrees and transmits it to a spindle 8. A grindstone 8a serving as a rotation tool (tip tool) is provided at the lower end of the spindle 8 so as to be integrally rotatable. Since the mechanical configuration and operation from the rotation of the motor 6 to the rotation of the grindstone 8a are well known, further detailed descriptions will be omitted.

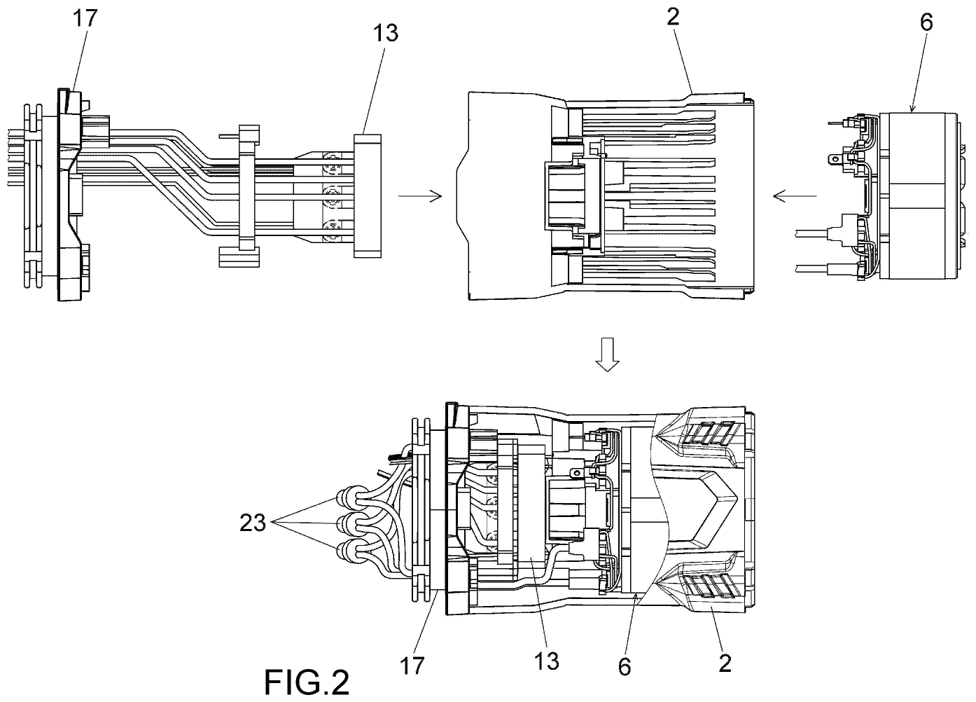

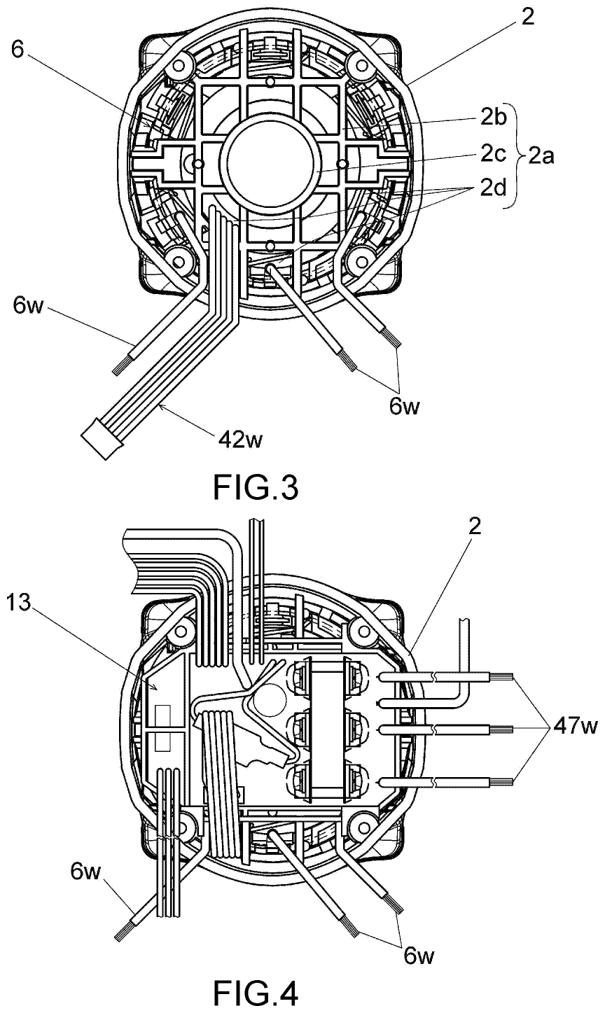

As shown in FIG. 2, the motor 6 is inserted into the motor housing 2 from the front and assembled. The control unit 13 is inserted into the motor housing 2 from the rear and assembled. The holder 17 is fixed to the rear end of the motor housing 2 by screws or the like. FIG. 3 is a rear view of the motor housing 2 incorporating the motor 6. The motor housing 2 has a bearing holding part 2a. The bearing holding part 2a is positioned between the motor 6 and the control unit 13 in the front-and-back direction. The bearing holding part 2a includes ribs 2b and a bearing housing part 2c. The ribs 2b extend in a grid shape across the inner peripheral surfaces of the motor housing 2. A plurality of through holes 2d are formed between the inner surface of the motor housing 2 and the bearing housing part 2c by the ribs 2b that have a grid shape. That is, the bearing holding part 2a has a plurality of through holes 2d penetrating in the front-and-back direction. In the present embodiment, 20 through holes 2d are provided. The bearing housing part 2c is supported by the ribs 2b and houses and holds a bearing 6c. The bearing 6c rotatably supports the rear portion of the rotation shaft 6a of the motor 6. Through the gaps (through holes 2d) between the ribs 2b, a wiring 6w extending from a stator coil of the motor 6, and a signal line 42w extending from a sensor board 40, which has a magnetic sensor (Hall element or the like) for detecting the rotational position of the motor 6, extend rearward. Although a plurality of through holes 2d are provided, the wiring 6w and the signal line 42w pass through the through holes 2d at different positions, so that it is possible to prevent contact between the wiring 6w and the signal line 42w. Further, in the present embodiment, three wirings 6w are provided, which pass through the through holes 2d at different positions. Thus, it is possible to restrict the positional change of the plurality of wirings 6w and prevent contact between the wirings 6w. In addition, the wiring 6w and the signal line 42w pass through the through holes 2d so that the movement of the wiring 6w and the signal line 42w is restricted by the ribs 2b around. That is, since unnecessary movement of the wiring 6w and the signal line 42w is restricted by the bearing holding part 2a, it is easy to connect and assemble the wirings. In the present embodiment, in order to form the through holes 2d, the ribs 2b extending vertically and horizontally forms a grid shape. However, the through holes may be formed by a plurality of ribs extending in one direction, and for example, a fence may be formed by a plurality of ribs extending vertically. Furthermore, in the present embodiment, the plurality of wirings 6w are configured to pass through the through holes 2d at different positions. However, the above-mentioned effect can be achieved if at least two wirings pass through the through holes 2d at different positions. Moreover, the plurality of through holes that restrict the movement of the wirings are also used as a part of the bearing holding part 2a, but the plurality of through holes may be provided at other positions. The ribs 2b and the through holes 2d correspond to the grid part of the invention.

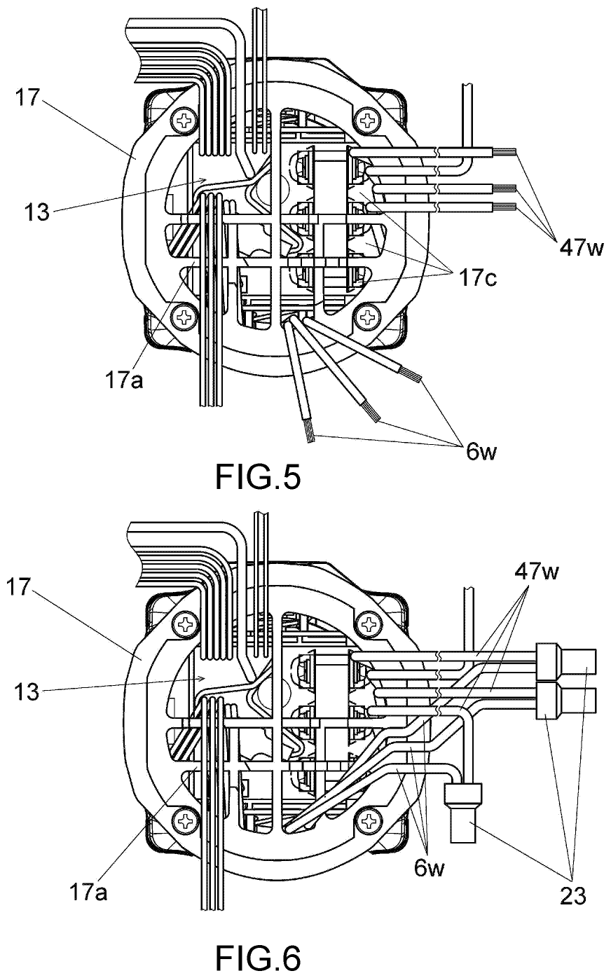

FIG. 4 is a rear view of the motor housing 2 incorporating the control unit 13 from the state of FIG. 3. The control unit 13 is equipped with a switching element, a microcomputer, and the like that constitute the inverter circuit on the rear surface of the control board. The wirings 47w are wirings for supplying power to the motor 6, which extend from the inverter circuit. FIG. 5 is a rear view of a state where the holder 17 is installed on the motor housing 2 of FIG. 4. The holder 17 has a cylindrical shape extending in the front-and-back direction, and has a front end and a rear end that are open. The holder 17 has grid-shaped ribs 17a. A plurality of ribs 17a having a grid shape similar to the ribs 2b form through holes 17c that penetrate in the front-and-back direction. Through the gaps (through holes 17c) between the ribs 17a, the wirings 6w and the wirings 47w extend rearward. The ribs 17a that form a grid-shaped structure have an effect of restricting the positional change of the wirings, similarly to the ribs 2b. In the state of FIG. 5, the wirings 6w and the wirings 47w are not connected, that is, a state where the motor 6 and the control unit 13 are not electrically connected. As shown in FIG. 5, the tips of the wirings 6w and 47w before connection are in a state where the insulating material has been removed. FIG. 6 is a rear view of a state where the wirings 6w and 47w of FIG. 5 are mechanically and electrically connected to each other by the connectors 23. The wirings 6w and the wirings 47w whose tips are not insulated in the state of FIG. 5 are connected to each other at the tips. The connection is carried out by a method (caulking process) in which the tip portions are brought into contact with each other and pressure is applied to fix them. The connector 23 is included in the electrical connection part between the wiring 6w and the wiring 47w, that is, the electrical connection part between the motor 6 and the control unit 13, the connector 23 is an insulating member that partially covers the wiring 6w and the wiring 47w. The connector 23 covers the connected tips of the wiring 6w and the wiring 47w and the vicinity thereof. Further, the inside of the connector 23 is configured to be equal to or slightly smaller than a size that combines the thicknesses of the wiring 6w and the wiring 47w, and the wiring 6w and the wiring 47w are prevented from coming off from the connector 23 due to a frictional force or the like. As shown in FIG. 1, the connector 23 is positioned outside (behind) the motor housing 2. Specifically, the connector 23 is positioned inside the handle housing 3. As shown in FIG. 5 and FIG. 6, the wiring 6w and the wiring 47w are connected to each other through the through holes 17c at different positions. That is, the final connection line between the motor 6 and the control unit 13 extends from the motor 6, extends to the outside of the motor housing 2, passes through the through hole 17c rearward, then passes over the rib 17a, passes through another through hole 17c forward, returns to the inside of the motor housing 2, and reaches the control unit 13. Therefore, the movement of at least a part of the connection line (wiring 6w or 47w) between the motor 5 and the control unit 13 positioned outside the motor housing 2 is restricted by the rib 17a. The through hole 17c corresponds to the holder through hole of the invention. In the drawing, the lead wires are drawn only from a part of the through holes 17c, but in the present embodiment, eight through holes 17c in total are provided.

According to the present embodiment, the electrical connection part (connector 23) between the wiring 6w of the motor 6 and the wiring 47w of the control unit 13 is arranged outside the motor housing 2, so it is possible to prevent the electrical connection part from contacting a part of the control unit 13. In particular, even if the elements such as the switching element and the microcomputer constituting the inverter circuit of the control unit 13, other electricity conducting portions, heat sinks, etc. in the motor housing 2 are exposed, it is still possible to prevent the risk of problems caused by contact between these and the parts, from which the insulating coating is removed, of the wirings 6w and 47w. Furthermore, since it is not necessary to take up a space for disposing the connector 23 in the motor housing 2, it is possible to prevent the size of the motor housing 2 from increasing, and the flow of the cooling air passing through the inside of the motor housing 2 in the front-and-back direction is not hindered. Since there is a relatively sufficient space in the handle housing 3 in which the connector 23 is positioned, there is no problem even if the connector 23 is disposed. In addition, since it is possible to dispose the connector 23 inside the handle housing 3 that has a sufficient space, it is possible to adopt a relatively inexpensive but large connector member to realize an inexpensive electric work machine. Further, according to the present embodiment, when the connection work for the wiring 6w and the wiring 47w is performed, the motor 6 and the control unit 13 are both supported by the motor housing 2, so they are prevented from moving relative to each other. Therefore, compared with a case where only one of them is supported, the connection work is very easy to perform.

### Second Embodiment

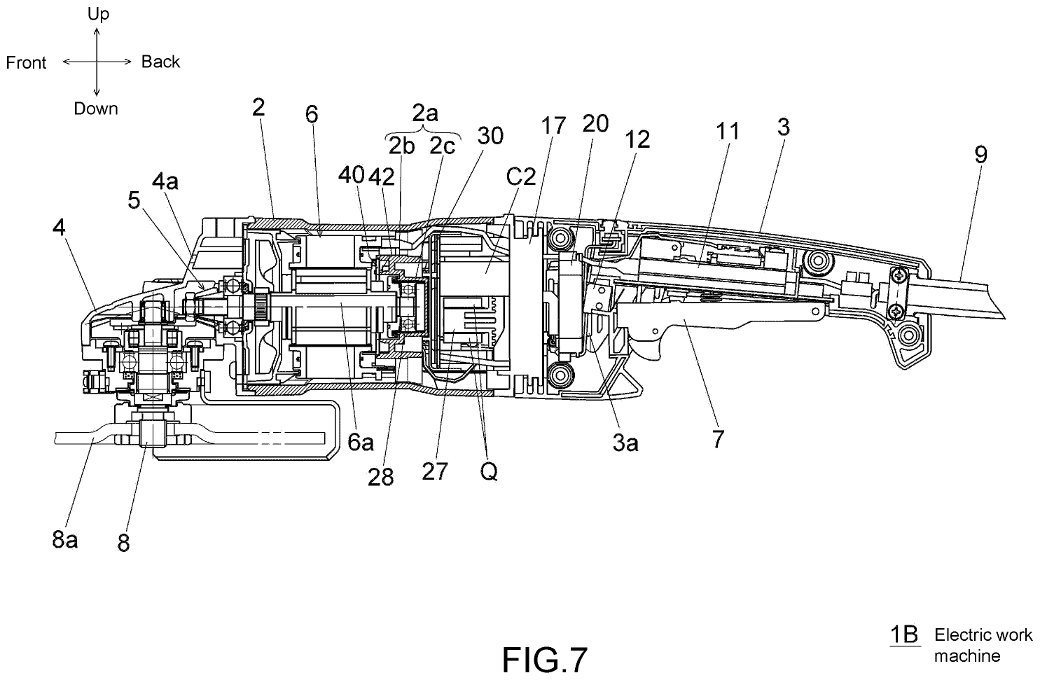

An electric work machine 1B according to the second embodiment of the invention will be described with reference to FIG. 7 to FIG. 12. The up-and-down and front-and-back directions of the electric work machine 1B are defined by FIG. 7. The front-and-back direction is parallel to the extending direction of the rotation shaft 6a of the motor 6. The electric work machine 1B is a corded type grinder that operates with the power supplied from an external AC power supply. Hereinafter, the differences from the first embodiment will be mainly described.

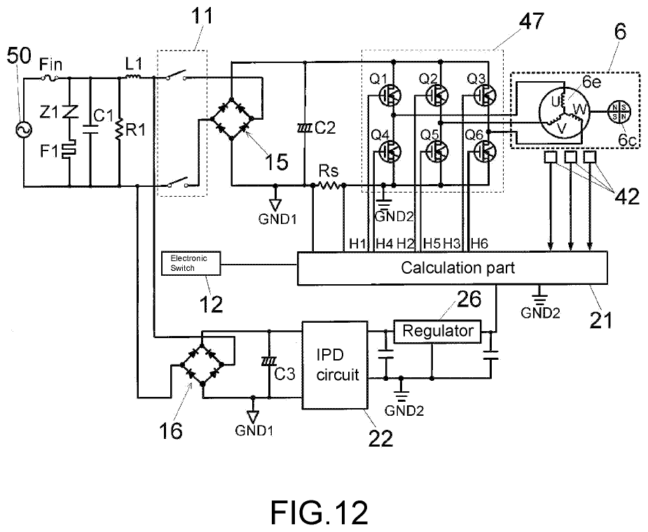

A power cord 9 for connecting to an external AC power supply 50 (FIG. 12) extends from the rear end of the handle housing 3. A controller 20, in which an auxiliary power supply/control board is housed, is provided in the front portion of the handle housing 3. Intake ports 3a are provided on the left and right side surfaces of the handle housing 3 as in the first embodiment. A second switch 12 is provided at a position on the front side of the trigger 7. The second switch 12 is, for example, an electronic switch (micro switch or the like) electrically connected to a calculation part 21 of FIG. 12, and is turned on/off in conjunction with the operation of the trigger 7. The second switch 12 is provided in order to quickly transmit the operation of the trigger 7 to the calculation part 21, and sends out signals of different levels to the calculation part 21 depending on whether it is turned on or off. When the user holds the trigger 7, the trigger 7 swings upward and the second switch 12 is turned on. When the user releases the trigger 7, the trigger 7 swings downward and the second switch 12 is turned off.

The motor housing 2 houses the motor 6 and houses a bridge/inverter board (drive board) 30 in the rear portion of the motor 6. On the rear surface of the bridge/inverter board 30, switching elements Q (corresponding to the switching elements Q1 to Q6 of FIG. 12) constituting the inverter circuit 47 of FIG. 12, heat sinks 27 (heat dissipation member) for cooling the switching elements Q, an electrolytic capacitor C2, etc. are provided. The bearing holding part 2a is provided between the motor 6 and the bridge/inverter board 30.

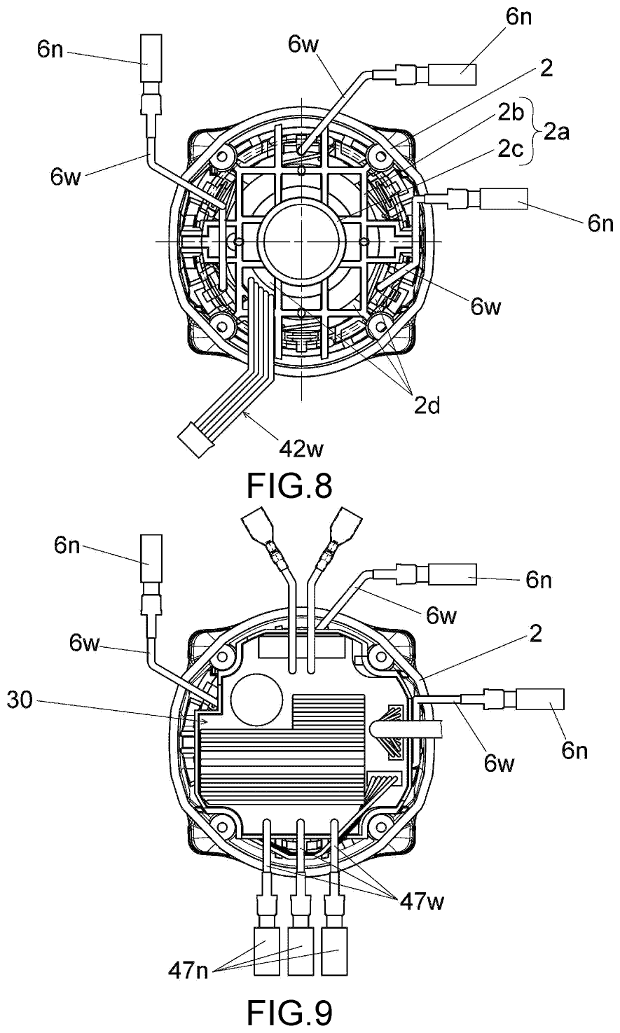

The motor 6 is inserted into the motor housing 2 from the front and assembled. The bridge/inverter board 30 is inserted into the motor housing 2 from the rear and assembled. The holder 17 is fixed to the rear end of the motor housing 2 by screws or the like. FIG. 8 is a rear view of the motor housing 2 incorporating the motor 6. The bearing housing part 2c is supported by the ribs 2b and houses and holds a bearing 28 of FIG. 7. The bearing 28 rotatably supports the rear portion of the rotation shaft of the motor 6. A connector 6n is provided at the tip of the wiring 6w. The connector 6n is a connection component fixed to the tip of the wiring 6w and has a metal portion covered with an insulating material, and is engageable with a connector 47n described later.

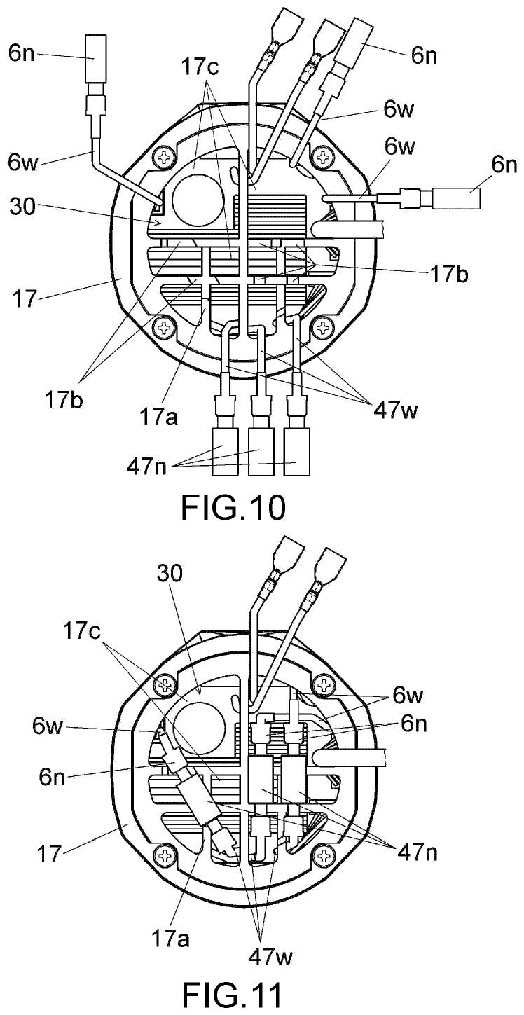

FIG. 9 is a rear view of the motor housing 2 incorporating the bridge/inverter board 30 from the state of FIG. 8. The wiring 47w is a wiring extending from the inverter circuit provided on the bridge/inverter board 30. The connector 47n is provided at the tip of the wiring 47w. The connector 47n is a connection component fixed to the tip of the wiring 47w and has a metal portion covered with an insulating material, and is engageable with the metal portion of the connector 6n. FIG. 10 is a rear view of a state where the holder 17 is installed on the motor housing 2 of FIG. 9. The wirings 6w and 47w extend rearward through the gaps (through holes 17c) between the ribs 17a of the holder 17. FIG. 11 is a rear view of a state where the connectors 6n and 47n of FIG. 10 are connected to each other and fitted into the recesses 17b of the holder 17. By connecting the connectors 6n and 47n to each other, the wirings 6w and 47w are mechanically and electrically connected to each other. The insulating portions of the connectors 6n and 47n partially cover the wiring 6w and the wiring 47w. The interconnection part of the connectors 6n and 47n is the electrical connection part of the wirings 6w and 47w, that is, the electrical connection part between the motor 6 and the bridge/inverter board 30. As shown in FIG. 10, the ribs 17a have a plurality of recesses 17b. As shown in FIG. 11, the connectors 6n and 47n and the interconnection part thereof are fitted and held in the recesses 17b. The handle housing 3 may also have ribs that press down the connectors 6n and 47n and the interconnection part thereof held in the recesses 17b from the rear.

FIG. 12 is a circuit diagram of the electric work machine 1B. The AC power supply 50 is an external AC power supply such as a commercial power supply. A filter circuit including a fuse Fin, a varistor Z1, a pattern fuse F1, a capacitor C1, a resistor R1, and a choke coil L1 is connected to the AC power supply 50. The fuse Fin is for protection when the switching elements Q1 to Q6 are short-circuited. The varistor Z1 is for absorbing a surge voltage. The pattern fuse F1 has a role of preventing short-circuiting between lines when the varistor Z1 operates. The capacitor C1 and the choke coil L1 are for removing noise between lines. The resistor R1 is for discharging the capacitor C1.

The first switch 11 is provided between the output side of the above-mentioned filter circuit and the input side of the diode bridge 15. The first switch 11 is a two-pole switch, and is capable of opening and closing both between one output terminal of the filter circuit and one input terminal of the diode bridge 15, and between the other output terminal of the filter circuit and the other input terminal of the diode bridge 15. The diode bridge 15 serving as a rectifying circuit full-wave rectifies the output voltage of the above-mentioned filter circuit input via the first switch 11 to convert it into a direct current, and supplies it to the inverter circuit 47. The electrolytic capacitor C2 is for absorbing surge and is provided between the output terminals of the diode bridge 15. The resistor Rs is a detection resistor for detecting the current flowing through the motor 6, and is provided in the current path of the motor 6. The diode bridge 15, the electrolytic capacitor C2, the inverter circuit 47 serving as the first control unit, and the resistor Rs are provided on the bridge/inverter board 30 of FIG. 7.

The inverter circuit 47 includes the switching elements Q1 to Q6 such as IGBTs and FETs connected in a three-phase bridge, performs a switching operation according to the control of the calculation part 21 serving as the second control unit, and supplies a drive current to the stator coil 6e (each wiring of U, V, W) of the motor 6. The calculation part 21 detects the current of the motor 6 by the voltage across the resistor Rs. Further, the calculation part 21 detects the rotational position (rotor rotational position) of the motor 6 by the output voltage of a plurality of Hall elements (magnetic sensors) 42. The calculation part 21 controls driving and braking of the motor 6 according to the state (on/off) of the second switch 12 which is interlocked with the operation of the trigger 7. Specifically, when the second switch 12 is turned on by the operation of the trigger 7, the calculation part 21 performs switching control (for example, PWM control) on the switching elements Q1 to Q6 and controls the driving of the motor 6. When the second switch 12 is turned off by the operation of the trigger 7, the calculation part 21 performs control (brake control) that applies a braking force to the motor 6. The brake control is, for example, control for generating an electric braking force by continuously or intermittently turning on at least one of the lower arm side switching elements Q4 to Q6 while keeping the upper arm side switching elements Q1 to Q3 of the inverter circuit 47 off.

The other diode bridge 16 serving as a rectifying circuit full-wave rectifies the output voltage of the above-mentioned filter circuit input not via the first switch 11 to convert it into a direct current. The electrolytic capacitor C3 is for absorbing surge and is provided between the output terminals of the diode bridge 16. An IPD circuit 22 is provided on the output side of the diode bridge 16. The IPD circuit 22 is a circuit constituted by an IPD element, a capacitor, or the like, which is an intelligent power device, and is a DC-DC switching power supply circuit that steps down the voltage rectified and smoothed by the diode bridge 16 and the surge absorbing electrolytic capacitor C3 to, for example, about 18V. The IPD circuit 22 is an integrated circuit and has an advantage of low power consumption and energy saving. The output voltage of the IPD circuit 22 is further stepped down to, for example, about 5V by a regulator 26 and supplied to the calculation part 21 as an operating voltage (power supply voltage Vcc). The diode bridge 16, the electrolytic capacitor C3, the calculation part 21, the IPD circuit 22, the regulator 26, etc. are provided on the auxiliary power supply/control board 20.

In the present embodiment, as in the first embodiment, the electrical connection part (interconnection part of the connectors 6n and 47n) between the wiring 6w of the motor 6 and the wiring 47w extending from the bridge/inverter board 30 is disposed outside the motor housing 2. Therefore, even if the electricity conducting portions such as the switching elements constituting the inverter circuit of the bridge/inverter board 30, heat sinks, etc. in the motor housing 2 are exposed, it is still possible to prevent the risk of problems caused by contact between these and the parts, from which the insulating coating is removed, of the wirings 6w and 47w. Furthermore, in the present embodiment, because the auxiliary power supply/control board 20 is disposed in the front portion of the handle housing 3 (the space where the connector 23 is disposed in FIG. 1), there is no space in the front portion of the handle housing 3. However, by fitting and holding the connectors 6n and 47n and the interconnection part thereof in the recesses 17b of the ribs 17a of the holder 17, the connectors 6n and 47n and the interconnection part thereof can be preferably positioned outside the motor housing 2. In addition, since the connectors 6n and 47n and the interconnection part thereof are fixed to the holder 17, the interconnection part is not displaced by the vibration during work or the cooling air from the intake ports 3a to the exhaust ports 4a. Thus, it is possible to prevent contact between different interconnection parts, blocking of the air passage, etc.

Although the invention has been described above with the embodiments as examples, it will be understood by those skilled in the art that various modifications can be made to each component or process of the embodiments within the scope of the claims. Hereinafter, modified examples will be described.

The electric work machine of the invention may be an electric work machine other than the grinder illustrated in the embodiments, and in particular, it is suitable for an electric work machine having a motor housing that has a cylindrical integral structure and is molded so as not to be divided.

### DESCRIPTIONS OF REFERENCE NUMERALS

1A, 1B . . . electric work machine, 2 . . . motor housing, 3 . . . handle housing (tail cover), 4 . . . gear case, 5 . . . deceleration mechanism (rotation transmission mechanism), 6 . . . motor, 6n . . . connector, 6w . . . wiring, 7 . . . trigger, 8 . . . spindle, 8a . . . grindstone, 9 . . . power cord, 11 . . . first switch (contact switch), 12 . . . second switch (electronic switch), 13 . . . control board, 14 . . . battery pack, 15, 16 . . . diode bridge, 17 . . . holder (intermediate member), 17a . . . rib, 17b . . . recess, 20 . . . controller, 21 . . . calculation part (second control unit), 22 . . . IPD circuit, 23 . . . connector (wiring member), 26 . . . regulator, 27 . . . heat sink (heat dissipation member), 28 . . . bearing, 30 . . . bridge/inverter board (drive board), 40 . . . sensor board, 42 . . . Hall element (magnetic sensor), 47 . . . inverter circuit (first control unit), 47n . . . connector, 47w . . . wiring, 50 . . . AC power supply

1. An electric work machine, comprising:
a motor housing that supports a motor and a first control unit controlling the motor,
wherein an electrical connection part between the motor and the first control unit is positioned outside the motor housing.

2. The electric work machine according to claim 1, wherein the electrical connection part is formed by connecting a motor side wiring extending from the motor and a control unit side wiring extending from the first control unit.

3. The electric work machine according to claim 2, wherein the electrical connection part comprises a connector that at least partially covers the motor side wiring and the control unit side wiring which are connected.

4. The electric work machine according to claim 3, wherein the first control unit comprises a switching element for conducting electricity to the motor.

5. The electric work machine according to claim 3, wherein a holder is provided on an electrical connection part side of the motor housing,
a plurality of holder through holes are provided in the holder, and
the motor side wiring is inserted into one of the holder through holes.

6. The electric work machine according to claim 5, wherein the control unit side wiring is inserted into another one of the holder through holes at a position different from the holder through hole through which the motor side wiring passes.

7. The electric work machine according to claim 5, wherein a connector holding part that holds the connector is provided in the holder.

8. The electric work machine according to claim 5, wherein a gear case is connected to one side of the motor housing, and
the electrical connection part is positioned on the other side with respect to the motor housing.

9. The electric work machine according to claim 8, wherein a handle housing is provided on the other side of the motor housing, and
the electrical connection part is positioned inside the handle housing.

10. The electric work machine according to claim 9, wherein a second control unit that controls the first control unit is housed inside the handle housing.

11. The electric work machine according to claim 10, wherein the handle housing is held by the motor housing via the holder.

12. The electric work machine according to claim 11, comprising:
a fan rotated by the motor; and
an intake port and an exhaust port for generating a flow of air that cools the motor by rotation of the fan,
wherein the air flowing from the intake port flows into the motor housing through the holder through holes.

13. The electric work machine according to claim 3, wherein in the motor housing, a plurality of through holes are formed by a plurality of ribs extending from an inner surface of the motor housing, and
the motor side wiring is connected to the control unit side wiring through the through holes.

14. The electric work machine according to claim 13, wherein a plurality of the motor side wirings is provided, and
at least two of the plurality of motor side wirings pass through the through holes at different positions.

15. The electric work machine according to claim 13, wherein a bearing holding part that holds a bearing supporting a rotation shaft of the motor is positioned between the motor and the first control unit, and
the through holes are provided in the bearing holding part.
